(19) United States
(12) Patent Application Publication
(10) Pub. No.: US 2010/0202640 A1
(43) Pub. Date: Aug. 12, 2010

(54) Exterior power supply for hearing aid

(76) Inventors: Chum Lee, Taipei County (TW); Huey-Ling Kao Ulrey, Scottsdale, AZ (US)

Correspondence Address: BACON & THOMAS, PLLC, 625 SLATERS LANE, FOURTH FLOOR, ALEXANDRIA, VA, 22314-1176, US

(21) Appl. No.: 12/320,956

(22) Filed: Feb. 10, 2009

(51) Int. Cl. H04R 25/00

(52) U.S. Cl. 381/317; 381/323

(57) ABSTRACT

An exterior power supply consists a positive and negative power contacts located in the hearing aid, a wire, and a power supply. The electrode contacts use two pieces of thin plate connecting to the wire, which passes through the battery container without modifying the structure of the hearing aid. At the other end of the wire is the power supply that can be a combination of a solar cell with a chargeable battery, or a normal small battery. The multi-functional power supply has a circuit offering an electricity conduction circuit, an auto loud noise control circuit detecting background noise volume and being stopped temporarily as though the noise is overloaded and started automatically once the background noise volume is back to the normal level, and a voltage regulator circuit to control an output voltage always be 1.4 V.

### BACKGROUND OF THE INVENTION

1. Field of the Invention

The present invention relates to using an exterior power supply to replace any size of button cell in a hearing aid.

2. Background of the Invention

The present invention is aimed at developing an exterior power supply to the hearing aid using the button cell, more particularly providing the electricity from an exterior power supply through a wire to a hearing aid in order to replace the button cell. The exterior power supply comprises a set of auto loud noise control circuit, which is capable of detecting background noise volume. The power supply will be stopped temporarily as though the noise is overloaded and will be started automatically once the background noise volume is back to the normal level to protect the hearing aid user's listening comprehension and conserve the button cell consumption.

### SUMMARY OF THE INVENTION

The main objective of the invention is to provide an exterior power supply to a hearing aid. This exterior power supply consists a positive and negative power contacts located in the hearing aid, a wire, and a power supply. The electrode contacts use two pieces of thin plate connecting to the wire, which passes through the battery container without modifying the structure of the hearing aid. At the other end of the wire is the power supply that can be a combination of a solar cell with a chargeable battery, or a normal small battery. The multi-functional power supply has a circuit offering an electricity conduction circuit, an auto loud noise control circuit detecting background noise volume and being stopped temporarily as though the noise is overloaded and started automatically once the background noise volume is back to the normal level, and a voltage regulator circuit to control an output voltage always be 1.4 V.

### BRIEF DESCRIPTION OF THE DRAWINGS

FIG. 1 is a perspective view showing an exterior power supply to a hearing aid in accordance with present invention.

FIG. 2 is an exploded perspective view of the power supply electrode contact in accordance with the present invention.

FIG. 3 is an exploded perspective view of the exterior power supply in accordance with the present invention.

FIG. 4 is a circuit diagram of the exterior power supply in accordance with the present invention.

FIGS. 5a and 5b are operational views of the exterior power supply in accordance with the present invention.

### DETAILED DESCRIPTION OF THE PREFERRED EMBODIMENT

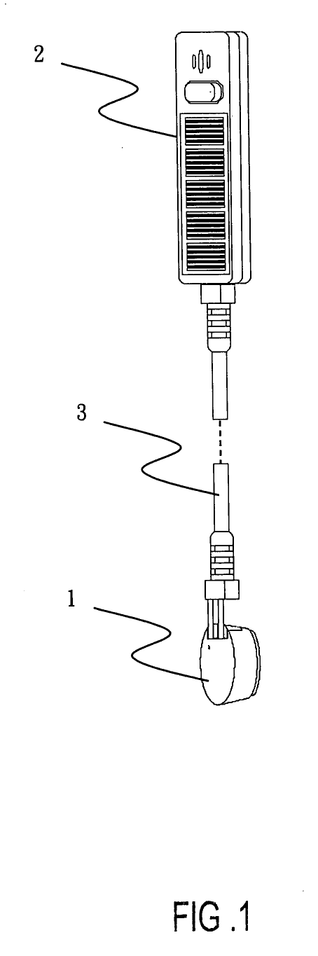

Please referring to FIG. 1, the present invention consists the positive and negative power contacts 1 located in the hearing aid, a power supply 2, and a wire 3.

Basically the model of the power electrode contacts is similar with the button cell and the size is manufactured according to the size of button cell used by the hearing aid (such as battery number 675, 13, 312, 10, and 5 etc.).

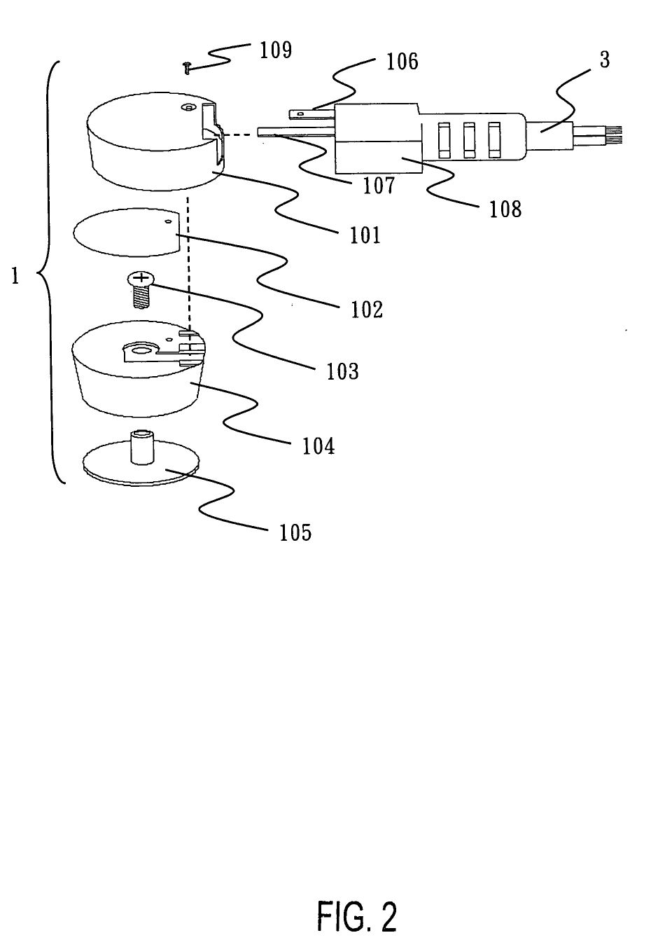

As illustrated in FIG. 2, the electrode contacts has a positive electrode metal case 101; the other end of the wire 3 connects to the positive and negative output of the power supply 2 and this end connects to metal electricity conduction plates 106 (positive) and 107 (negative) separately. Both plates are under PVC plastic 108 and only exposed appropriate length. Both plates are inserted into the metal case 101. The plate 107 was locked with the plastic base 104 and the negative electrode contact 105 with the screw 103 in order to conduct negative electricity to the negative electrode contact 105 from the power supply 2. An isolation washer 102 is placed on the screw 103; the positive electrode case 101 is used to cover the whole assembly; with the screw 109 going through the holes of the metal case 101, the electricity conduction plate 106, and the isolation washer 102 to screw tightly with the plastic base 104 to assure the electricity conduction plate 106 not loose caused by pulling.

Finally compressing the opening of positive electrode 101 with the plastic base 104 by applying the crimping tool and that completes the construction of the positive and negative electrode contacts 1.

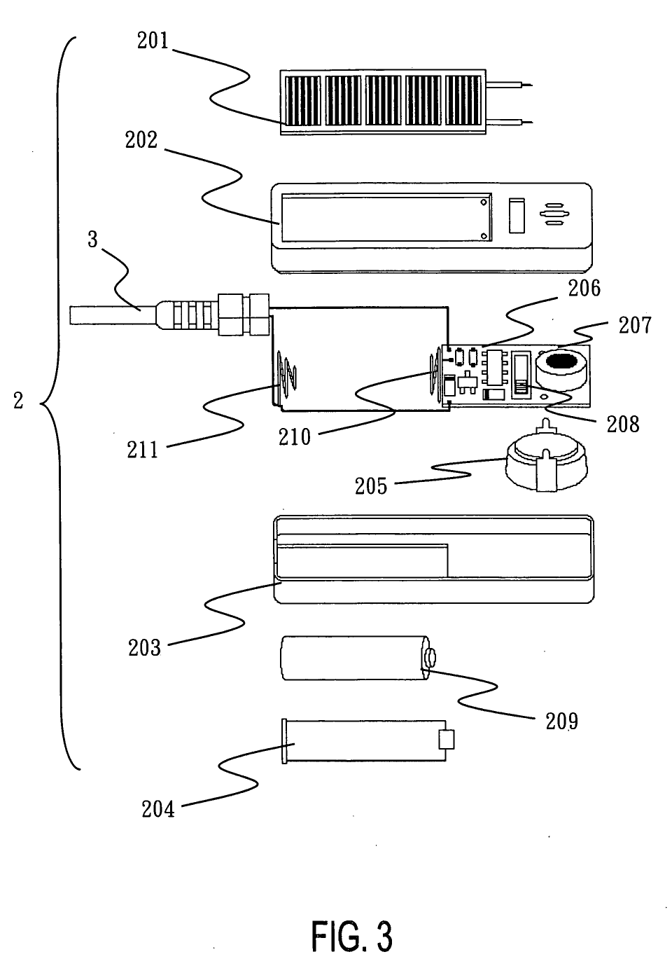

Regarding the power supply 2 please refer to FIG. 3. In the drawing, the wire 3 connects to the circuit board 206 and the negative electricity conduction wire also connects to the battery spring 211. The solar cell 201 is stuck firmly with the plastic case 202 and the wire passes through the case 202 and connects to the power input in the circuit board 206. The chargeable battery 205 is welded on the bottom of the circuit board 206. The circuit board 206 is placed inside of the plastic case 203 and the wire 3 is placed between the sides of the plastic cases of 202 and 203. Also both cases 202 and 203 are glued together. When the normal battery 209 is using, the battery is placed to the opening of the bottom of the plastic case 203 which located between the battery springs 210 and 211 then close the battery container 204.

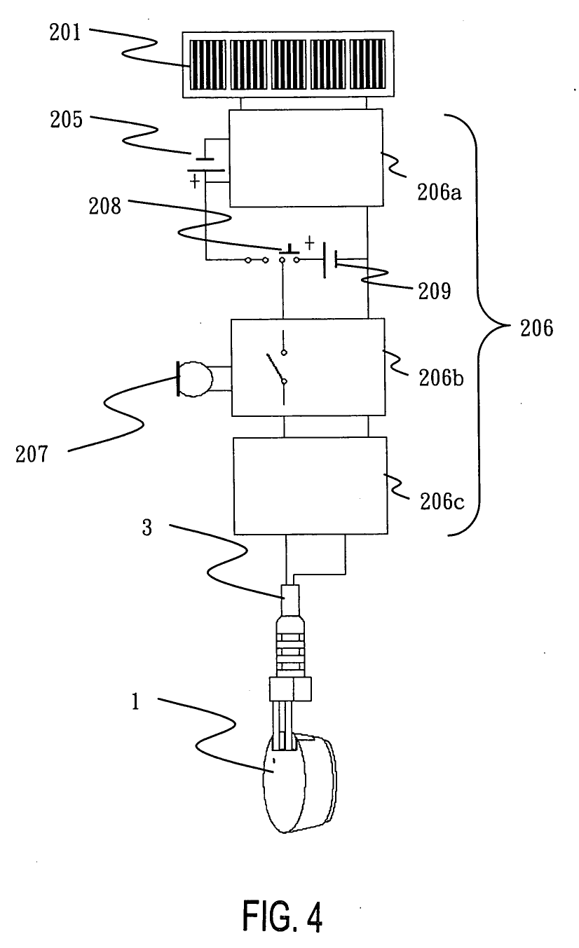

Please refer to FIG. 4 for the electricity construction of the power supply. In the circuit board 206 there is a power ON/OFF switch 208 which offering a choice of solar cell, regular battery, or shut down. The circuit board comprises a power charging circuit 206a (regulate the output voltage of the solar cell to avoid shortening the usage of chargeable battery 205), an auto loud noise control circuit 206b (use a microphone 207 to obtain the background noise, calculate the volume, and control the noise under 84 dB for stopping and/or restarting the power supply), and a regulator circuit 206c (a voltage set up circuit and voltage regulator which will boost up the voltage from the chargeable battery 205 (1.2V) and/or the regular battery 209 (1.5V) to 1.8V then regulate the power on the wire 3 to 1.4V and pass to the contact 1).

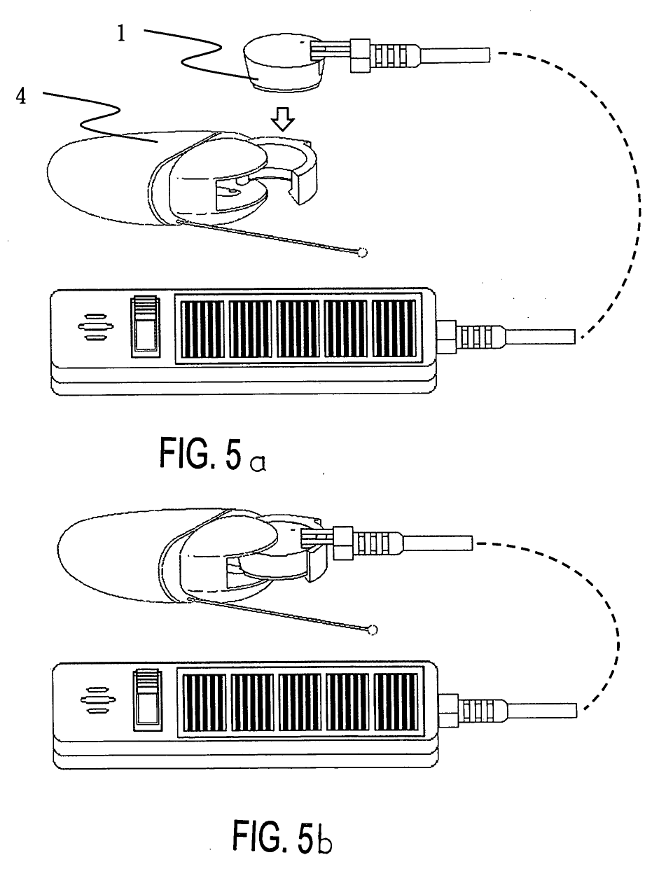

As illustrated in FIG. 5a, the consumer will insert the electrode contact 1 on the top of the battery container 4 (as showed in FIG. 5b) and close the container then he or she will be able to start using the hearing aid. The power supply can be hooked on the collar, the sleeve, or the front of the clothes to avoid hooking up with the wire.

In conclusion, the current invention is an exterior power supply to a hearing aid not only converting the current regular battery to the chargeable battery but also stopping the power supply temporarily as though the background noise is overloaded and starting automatically once the background noise volume is back to the normal level to protect the hearing aid user's listening comprehension. This invention actually is a very creative brand new product.

What is claimed is:

1. An exterior power supply for hearing aid, including:
a positive and negative power contact that is similar to the button cell and the size is manufactured according to the size of button cell used by the hearing aid (such as battery number 675, 13, 312, 10, and 5 etc.) and it has two pieces of metal electricity conduction to connect to the wire; and
a power supply which connecting to the above-mentioned contact through a wire.

2. The exterior power supply as claimed in claim 1, wherein the electrode contact is easily placed in the battery container of the hearing aid.

3. The exterior power supply as claimed in claim 1, wherein the two pieces of metal electricity conduction are used to pass through the space between the hearing aid case and the battery.

4. The exterior power supply as claimed in claim 1, wherein the auto loud noise control circuit detecting background noise volume and being stopped temporarily as though the noise is overloaded and started automatically once the background noise volume is back to the normal level.
